(19) United States
(12) Patent Application Publication
(10) Pub. No.: US 2004/0196440 A1
(43) Pub. Date: Oct. 7, 2004

(54) Projection type display apparatus

(76) Inventor: Hiroki Doda, Kitamoto-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/742,993

(22) Filed: Dec. 23, 2003

(30) Foreign Application Priority Data
Dec. 27, 2002 (JP) 2002-382267

(51) Int. Cl. G03B 21/16

(52) U.S. Cl. 353/52

(57) ABSTRACT

A projection type display apparatus includes a light-emitting unit emitting plural color lights, an image display unit including a predetermined number of reflection type light bulbs arranged on the same plane, each bulb having a display portion for displaying an image, the color lights being applied to the display portions, and the display portions modulating the applied color lights to correspond to the images and reflecting and outputting the modulated color lights, a light-composing unit composing the modulated color lights and outputting the composed image modulated light, and a common fixing member on which the light bulbs are provided, and which includes at least one of a common light-bulb-driving substrate and a common heat-radiating plate.

### CROSS-REFERENCE TO RELATED APPLICATIONS

This application is based upon and claims the benefit of priority from the prior Japanese Patent Application No. 2002-382267, filed Dec. 27, 2002, the entire contents of which are incorporated herein by reference.

### BACKGROUND OF THE INVENTION

1. Field of the Invention

The present invention relates to a projection type display apparatus.

2. Description of the Related Art

The Japanese Patent Application KOKAI Publication No. 2000-75427 discloses a conventional projection type display apparatus (hereinafter, this is referred as a projector). In this conventional projector, light from a light source is separated into red (R), green (G) and blue (B) lights by a light-separating unit using dichroic mirrors and reflecting mirrors. Each of the R, G and B lights is reflected by a color light polarization beam splitter corresponding thereto, and is applied to a reflection type light bulb for each of R, G and B lights. Each light bulb modulates the applied, polarized and separated R, G or B light to correspond to an image displayed thereon, and reflects the image-modulated R, G or B light toward the corresponding color light polarization beam splitter. Each of the image-modulated R, G or B light is analyzed by each color light polarization beam splitter, is composed by a color-composing prism, such as a cross dichroic prism, and then is projected through a projection lens.

In this conventional projector, a reflection type liquid crystal light bulb is used as the reflection type light bulb.

In the above-mentioned conventional projector, a power density of the color light applied to each reflection type light bulb is relatively high, and each reflection type light bulb is heated by the power of the applied color light. The degree of this heating in such a conventional projector is higher in a type thereof used for projecting an image on a larger screen.

A life of the reflection type light bulb using liquid crystal is shortened when it is heated to a high temperature. Thus, it is necessary to provide a heat-radiating plate on each reflection type liquid crystal light bulb in the conventional projector. Further, it is necessary to provide a heat discharge unit for discharging the radiated heat from each heat-radiating plate to the outside space, for example a ventilation pass, to each reflection type liquid crystal light bulb.

A demand for downsizing the projector always exits. However, the heat-radiating plate and the heat-discharging means for each reflection type liquid crystal light bulb make difficult to achieve this demand.

Further, in the configuration of the optical system of the above-mentioned conventional projector, the reflection type light bulbs for the R, G and B lights are separated from each other with a large space. This also makes it difficult to downsize the conventional projector.

Each of these reflection type light bulbs separated from each other with a large distance is connected to a driving circuit through a flexible cable. The flexible cable is likely to pick up an external electric noise and to leak out an electric noise to the outside.

### BRIEF SUMMARY OF THE INVENTION

According to an aspect of the present invention, a projection type display apparatus comprises: a light-emitting unit which emits a plurality of color lights; an image display unit which includes a predetermined number of reflection type light bulbs arranged on the same plane, each light bulb having an image display portion for displaying an image, the color lights being applied to the image display portions, and the image display portions modulating the applied color lights to correspond to the images, displayed on the image display portions, and reflecting and outputting the separated and modulated color lights; a light-composing unit which composes the predetermined number of image modulated color lights, outputted from the predetermined number of reflection type light bulbs included in the image display unit, and outputs the composed image modulated light; and a common fixing member on which the predetermined number of reflection type light bulbs are provided, and which includes at least one of a common driving substrate, having a driving circuit for driving the predetermined number of reflection type light bulbs, and a common heat-radiating plate.

Another aspect of the present invention, a projection type display apparatus, comprises: a light source which emits a light including at least three primary color lights; a light-separating unit which is applied with the light from the light source, separates the applied light into the three primary color lights, and outputs the separated three primary color lights to be in parallel to one axis at three positions isolated from each other; an image display unit which includes three reflection type light bulbs arranged on the same plane, each light bulb having an image display portion for displaying an image, the separated three primary color lights being applied to the image display portions, and the image display portions modulating the separated and applied three primary color lights to correspond to the images, displayed on the image display portions, and reflecting and outputting the separated and modulated three primary color lights; a light-composing prism which composes the three separated and image modulated primary color lights, outputted from the three reflection type light bulbs included in the image display unit, and outputs the composed image modulated light in a direction crossing the one axis; and at least three light polarization beam splitters which lead the three primary color lights outputted from the light-separating unit to the reflection type light bulbs included in the image display unit and corresponding to the three primary color lights, and leads the three separated and image modulated primary color lights, outputted from the corresponding reflection type light bulbs, to the light-composing prism.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows a main part of a projection type display apparatus according to an embodiment of the present invention;

FIG. 2A schematically shows a side view of optical paths of blue light B, red light R and green light G in the main part of the projection type display apparatus of FIG. 1 in a direction along a surface of a paper sheet showing FIG. 1;

FIG. 2B is an enlarged perspective view of three polarization beam splitters and three reflection type light bulbs arranged on the optical paths of blue light B, red light R and green light G in the main part of the projection type display apparatus, and a light composing prism of a light composing unit surrounded by the three polarization beam splitters;

FIG. 3 is a schematic perspective view of an optical box accommodating the main part of the projection type display apparatus of FIG. 1 and a light source combined with the optical box; and

FIG. 4 is a schematic longitudinal sectional view of a whole of a rear projection type screen unit, which uses the optical box combined with the light source, shown in FIG. 3.

### DETAILED DESCRIPTION OF THE INVENTION

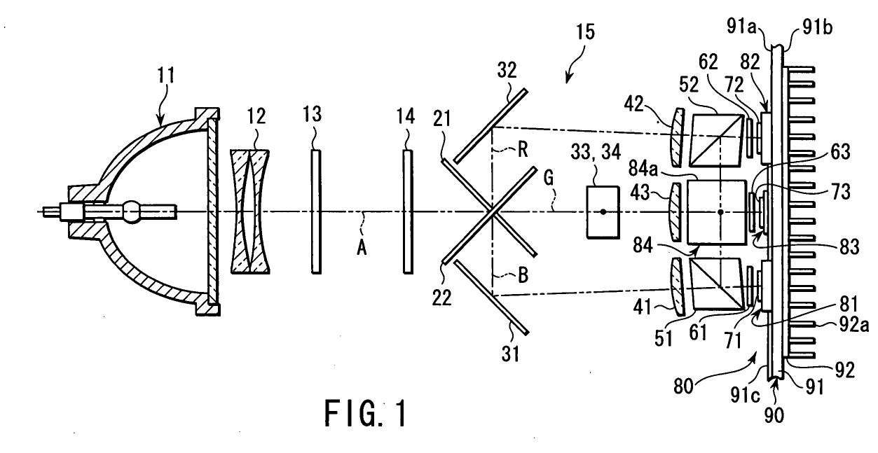

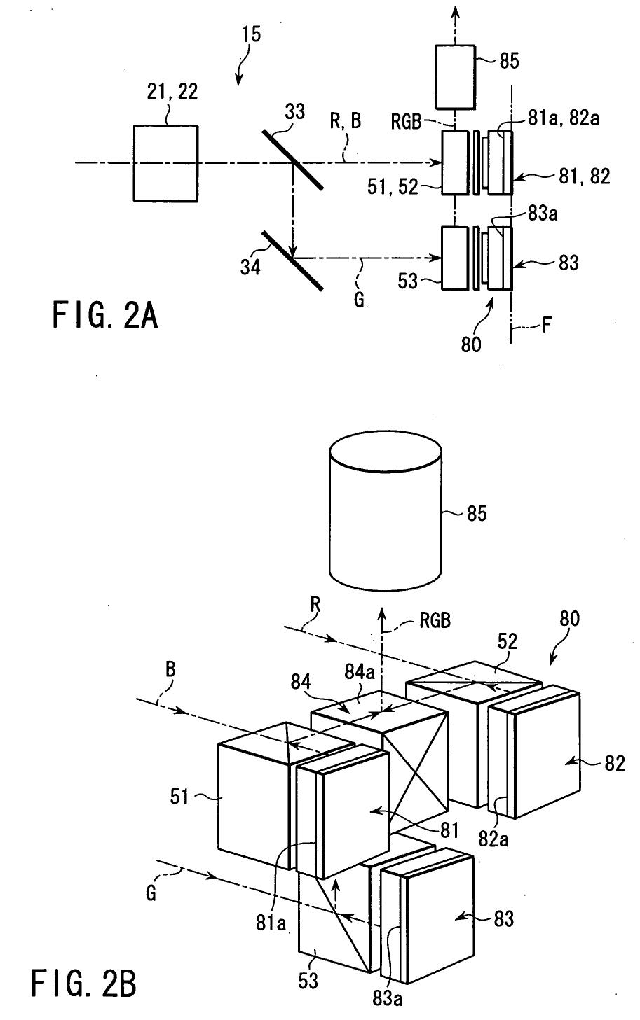

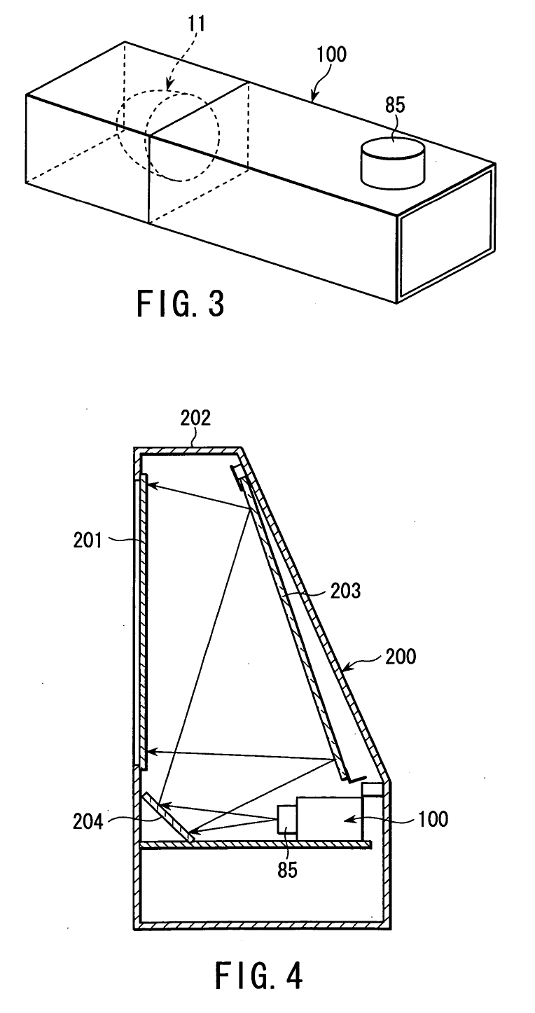

Now, a configuration of a projection type display apparatus (hereinafter, this is referred as a projector) according to an embodiment of the present invention will be described in detail with reference to FIGS. 1, 2A and 2B.

The projector comprises a light source 11 which is a kind of a color-light-emitting unit which emits a plurality of color lights, and emits a light including at least three primary colors. In this embodiment, the light source 11 has a high intensity lamp.

The light emitted from the light source 11 passes through a condenser lens 12, an optical filter 13 which cuts off ultraviolet rays and infrared rays, and a light polarization element 14, and is applied onto a light-separating unit 15, along one axis A. The light-separating unit 15 separates the plurality of color lights from the color-light-emitting unit into a predetermined number of color lights.

In this embodiment, the light-separating unit 15 uses a pair of dichroic mirrors 21 and 22 for separating three primary color lights (blue light B, red light R and green light G) from the applied light from the light source 11. After being separated, the blue light B and the red light R are directed in two directions, which are exactly opposing to each other and orthogonal to the above described one axis A along a surface of a paper sheet showing FIG. 1, and then are applied by a pair of first and second reflecting mirrors 31 and 32, which are arranged at two positions each of which is separated by the same distance as to each other from the axis A in each of the opposite directions, in a direction being in parallel to the axis A and along the surface of the paper sheet showing FIG. 1, and directing away from the light source 11.

After being separated as described above, the green light G advances straight coaxially with the axis A, and is directed by a reflecting mirror 33 downward orthogonal to the surface of the paper sheet showing FIG. 1. Then, the downward-directed green light G is applied in the direction being in parallel to the axis A and directing away from the light source 11 by a reflecting mirror 34.

That is, the three primary color lights (red light R, green light G and blue light B) separated by the light-separating unit 15, are applied in parallel to the axis A at three isolated positions in the light-separating unit 15. These three positions correspond to three vertexes of a virtual triangle, as shown well in FIG. B.

The three primary color lights (blue light B, red light R and green light G) from the light-separating unit 15 are passed through three light polarization beam splitters 51, 52 and 53, three phase difference plates 61, 62 and 63, and three light-polarizing plates 71, 72 and 73, those optical elements being correspond to the three primary color lights, and are applied to three reflection type light bulbs 81, 82 and 83 included in an image display unit 80. In this embodiment, each of these three reflection type light bulbs 81, 82 and 83 is a reflection type liquid crystal light bulb.

The three reflection type light bulbs 81, 82 and 83 have image display portions 81a, 82a and 83a, respectively, each of which displays a desired image using liquid crystal.

The three reflection type light bulbs 81, 82 and 83 are arranged at the three vertexes of the above-mentioned virtual triangle corresponding to the three separated positions of the three primary color lights (red light R, green light G and blue light B) applied from the light-separating unit 15, and are located on one virtual plane F which is orthogonal to the aforementioned one axis A.

The three image display portions 81a, 82aand 83a of the three reflection type light bulbs 81, 82 and 83 modulate the three separated primary color lights (blue light B, red light R and green light G) to correspond to the desired images displayed thereon, and reflect the three separated and modulated primary color lights toward the three light polarization beam splitters 51, 52 and 53, through the corresponding three light-polarizing plates 71, 72 and 73 and three phase difference plates 61, 62 and 63.

The three primary color image lights from the three reflection type light bulbs 81, 82 and 83 are composed by a light-composing unit 84, and then the composed image-modulated light is outputted in a predetermined direction.

More specifically, the light-composing unit 84 has a light-composing prism 84a at a position surrounded by the three light polarization beam splitters 51, 52, and 53, which are arranged at the three vertexes of the above-mentioned virtual triangle to face the three reflection type light bulbs 81, 82 and 83 on the optical axes of the three primary color lights (red light R, green light G and blue light B) from the light-separating unit 15.

The three image-modulated primary color image lights applied to the light composing prism 84a from the three reflection type light bulbs 81, 82 and 83 through the three light polarization beam splitters 51, 52 and 53, are composed by the light-composing prism 84a. The light-composing prism 84a outputs the composed color image light RGB in a predetermined direction crossing the aforementioned one axis A. Preferably, this color-image-light-outputting direction is orthogonal to the axis A, and is directing away from the light polarization beam splitter 53 for the green light G.

The composed color image light RGB outputted from the light-composing unit 84 in the above-mentioned predetermined direction, is projected on a not-shown screen through a projection lens 85.

The three reflection type light bulbs 81, 82 and 83 arranged on the same virtual plane F as described above, are fixed to a common fixing member 90. According to the aspect of the present invention, the common fixing member 90 includes at least one of a common driving substrate 91 having a driving circuit for driving the three reflection type light bulbs 81, 82 and 83, and a common heat-radiating plate 92 for leading heat generated from the three reflection type light bulbs 81, 82 and 83 to the outside space.

More specifically, in this embodiment, the common fixing member 90 includes both of the above-mentioned common driving substrate 91 and the common heat-radiating plate 92. The common driving substrate 91 has a fixing surface 91a on which the three reflection type light bulbs 81, 82 and 83 are fixed, and an opposite surface 91b which faces in a direction opposing to the fixing plane 91a. A driving circuit 91c for driving the three reflection type light bulbs 81, 82 and 83 is provided on the fixing plane 91a, and the common heat-radiating plate 92 is provided on the opposing surface 91b.

The common heat-radiating plate 92 has a first surface which is fixed to the opposite surface 91b of the common driving substrate 91, and a second surface which faces in a direction opposing to the first surface and is exposed to the outside space. A plurality of heat-radiating fins 92a is provided on the second surface.

According to the aspect of the present invention, the common fixing member 90 can has only the common driving substrate 91 or only the common heat-radiating plate 92.

When the common fixing member has only the common driving substrate 91, it is preferable to provide a known heat-radiating device other than the common heat-radiating plate 92, for leading the heat generated in the three reflection type light bulbs 81, 82 and 83 fixed to the common fixing member 90, to the outside space.

When the common fixing member has only the common heat-radiating plate 92, a known driving device having a driving circuit for driving the three reflection type light bulbs 81, 82 and 83, is electrically connected to the three reflection type light bulbs 81, 82 and 83 by a known signal transmission unit, such as a flat cable. Such a known signal transmission unit is preferably configured to prevent electric noises, which is included in light-bulb-driving signal transmitted through the known signal transmission unit, from leaking out from the known signal transmission unit to the outside space, and to prevent electric noises in the outer space from being picked up by the known signal transmission means.

In this embodiment, the three reflection type light bulbs 81, 82 and 83 for three primary color lights are arranged at the three vertexes of the virtual triangle, and the light-composing prism 84a of the light-composing unit 84 is arranged at the position surrounded by the three light polarization beam splitters 51, 52 and 53 corresponding to the three reflection type light bulbs 81, 82 and 83 arranged at the three vertexes of the virtual triangle, as described above. These configurations make outside dimensions of the projector of this embodiment being much reduced, compared with those of the aforementioned conventional projector.

Further, in this embodiment, the three reflection type light bulbs 81, 82 and 83 are fixed to the common fixing member 90, and the common fixing member 90 has at least one of the common driving substrate 91 and the common heat-radiating plate 92. Therefore, the outside dimensions of the projector of this embodiment can be much reduced, compared with those of the conventional projector in which the plurality of light bulbs have the plurality of heat-radiating member, respectively. More further, since the common fixing member 90 has the common driving substrate 91, it is also effectively possible to prevent the electric noises from leaking out from the driving circuit for the three reflection type light bulbs 81, 82 and 83, and also possible to prevent the above-mentioned driving circuit from picking up the electric noises in the outside space.

In the projector of this embodiment described above with reference to FIGS. 1, 2A and 2B, it is possible to accommodate various components, excepting the light source 11, in an optical box 100. The optical box 100 can be combined with the light source 11.

More specifically, the optical box 100 accommodates various components of the projector according to above-mentioned this embodiment: the condenser lens 12, the optical filter 13, the polarizing element 14, the light-separating unit 15 (a pair of dichroic mirrors 21 and 22, the first and second reflecting mirrors 31 and 32, and the third and fourth reflecting mirrors 33 and 34), the three light polarization beam splitters 51, 52 and 53, the three phase difference plates 61, 62 and 63, the three polarizing plates 71, 72 and 73, the image display unit 80 (the three reflection type light bulbs 81, 82 and 83), the light-composing unit 84 (the light composing prism 84a), and the projection lens 85.

The optical box 100 or the optical box 100 combined with the light source 11 can be independently handled or marketed.

The optical box 100 combined with the light source 11 can be installed in a rear projection type screen unit 200, as shown in FIG. 4. The rear projection type screen unit 200 includes a screen box 202, which supports a rear projection type screen 201 vertically. In the screen box 202, an inclined large reflecting mirror 203 is arranged in a rear side of the screen 201 to face the screen 201, an inclined small reflecting mirror 204 is arranged below the screen 201 to face the inclined large reflecting mirror 203, and the optical box 100 combined with the light source 11 is arranged below the inclined large reflecting mirror 203 to face the inclined small reflecting mirror 204.

In the rear projection type screen unit 200 shown in FIG. 4, a composed color image light outputted from the projection lens 85 of the optical box 100 is projected on the screen 201 from the rear side of the screen 201 through the inclined small reflecting mirror 204 and the inclined large reflecting mirror 203.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A projection type display apparatus comprising:
a light-emitting unit which emits a plurality of color lights;
an image display unit which includes a predetermined number of reflection type light bulbs arranged on the same plane, each light bulb having an image display portion for displaying an image, the color lights being applied to the image display portions, and the image display portions modulating the applied color lights to correspond to the images, displayed on the image display portions, and reflecting and outputting the separated and modulated color lights;
a light-composing unit which composes the predetermined number of image modulated color lights, outputted from the predetermined number of reflection type light bulbs included in the image display unit, and outputs the composed image modulated light; and
a common fixing member on which the predetermined number of reflection type light bulbs are provided, and which includes at least one of a common driving substrate, having a driving circuit for driving the predetermined number of reflection type light bulbs, and a common heat-radiating plate.

2. A projection type display apparatus according to claim 1, wherein the predetermined number of color lights from the plurality of color lights by the light-emitting unit are red light, green light, and blue light.

3. A projection type display apparatus according to claim 1, wherein the common fixing member includes the common driving substrate and the common heat-radiating member;
the common driving substrate has a fixing surface on which the predetermined number of reflection type light bulbs are fixed, and an opposite surface facing in a direction opposing to the fixing surface; and
the common heat-radiating member is provided on the opposite surface of the driving substrate.

4. A projection type display apparatus according to claim 3, wherein the heat-radiating member has a first surface provided on the opposite surface of the driving substrate, a second surface facing in a direction opposing to the first surface, and exposed to the outside space, and a plurality of heat-radiating fins provided on the second surface.

5. A projection type display apparatus, comprising:
a light source which emits a light including at least three primary color lights;
a light-separating unit which is applied with the light from the light source, separates the applied light into the three primary color lights, and outputs the separated three primary color lights to be in parallel to one axis at three positions isolated from each other;
an image display unit which includes three reflection type light bulbs arranged on the same plane, each light bulb having an image display portion for displaying an image, the separated three primary color lights being applied to the image display portions, and the image display portions modulating the separated and applied three primary color lights to correspond to the images, displayed on the image display portions, and reflecting and outputting the separated and modulated three primary color lights;
a light-composing prism which composes the three separated and image modulated primary color lights, outputted from the three reflection type light bulbs included in the image display unit, and outputs the composed image modulated light in a direction crossing the one axis; and
at least three light polarization beam splitters which lead the three primary color lights outputted from the light-separating unit to the reflection type light bulbs included in the image display unit and corresponding to the three primary color lights, and leads the three separated and image modulated primary color lights, outputted from the corresponding reflection type light bulbs, to the light-composing prism.

6. A projection type display apparatus according to claim 5, wherein the three isolated positions, at which the three primary color lights outputted from the light-separating unit to the three reflection type light bulbs included in the image display unit, are arranged to correspond to three vertexes of a triangle;
the three light polarization beam splitters are arranged to face the three reflection type light bulbs on three optical axes of the three primary color lights outputted from the light-separating unit to the three reflection type light bulbs included in the image display unit; and
the light-composing prism is arranged at a position surrounded by the three light polarization beam splitters on the three optical axes passing through the three vertexes of the triangle.

7. A projection type display apparatus according to claim 5, further comprising a common fixing member to which the plurality of reflection type light bulbs are provided, and which includes at least one of a common driving substrate having a driving circuit for driving the plurality of reflection type light bulbs, and a common heat-radiating plate.

8. A projection type display apparatus according to claim 7, wherein the common fixing member includes the common driving substrate and the common heat-radiating member;
the common driving substrate has a fixing surface on which the plurality of reflection light bulbs are fixed, and an opposing surface facing in a direction opposing to the fixing surface; and
the common heat-radiating member is provided on the opposing surface of the driving substrate.

9. A projection type display apparatus according to claim 8, wherein the common heat-radiating member has a first surface provided on the opposing surface of the driving substrate, a second surface facing in a direction opposing to the first surface, and exposed to the outside space, and a plurality of heat-radiating fins provided on the second surface.

10. A projection type display apparatus according to claim 5, further comprising an optical box which accommodates the light-separating unit, the image display unit, the light-composing prism, and the at least three light polarization beam splitters.
